(19) United States
(12) Patent Application Publication
(10) Pub. No.: US 2016/0038775 A1
(43) Pub. Date: Feb. 11, 2016

(54) Air Filtration Assembly

(71) Applicant: Frankie O'Neal Ward, JR., Prentiss, MS (US)

(72) Inventor: Frankie O'Neal Ward, JR., Prentiss, MS (US)

(21) Appl. No.: 14/453,249

(22) Filed: Aug. 6, 2014

(51) Int. Cl. A62B 23/02; A62B 18/02; A62B 18/08

(52) U.S. Cl. CPC A62B 23/025; A62B 18/082; A62B 18/02

(57) ABSTRACT

An air filtration assembly includes a mask that may be worn on a user's face. A pair of goggles is coupled to the mask. The pair of goggles covers the user's eyes when the user wears the mask. A sponge is coupled to the mask. A plurality of air intakes is coupled to the mask. The plurality of air intakes allows air to enter through the mask and the sponge when the user inhales. A plurality of fluid reservoirs is coupled to the mask. The plurality of fluid reservoirs each contains a fluid. The plurality of fluid reservoirs is compressed by the user when the user wears the mask. The fluid is dispersed into the sponge. The sponge filters particles from the air when the user inhales.

### BACKGROUND OF THE DISCLOSURE

1. Field of the Disclosure

The disclosure relates to filtration devices and more particularly pertains to a new filtration device for being worn by a user when the user is in a smoke filled environment wherein said assembly provides clean air for the user to breathe.

2. Summary of the Disclosure

An embodiment of the disclosure meets the needs presented above by generally comprising a mask that may be worn on a user's face. A pair of goggles is coupled to the mask. The pair of goggles covers the user's eyes when the user wears the mask. A sponge is coupled to the mask. A plurality of air intakes is coupled to the mask. The plurality of air intakes allows air to enter through the mask and the sponge when the user inhales. A plurality of fluid reservoirs is coupled to the mask. The plurality of fluid reservoirs each contains a fluid. The plurality of fluid reservoirs is compressed by the user when the user wears the mask. The fluid is dispersed into the sponge. The sponge filters particles from the air when the user inhales.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a air filtration assembly according to an embodiment of the disclosure.

FIG. 2 is a front view of an embodiment of the disclosure.

FIG. 3 is a back view of an embodiment of the disclosure.

FIG. 4 is a right side view of an embodiment of the disclosure.

FIG. 5 is a top view of an embodiment of the disclosure.

### DESCRIPTION OF THE PREFERRED EMBODIMENT

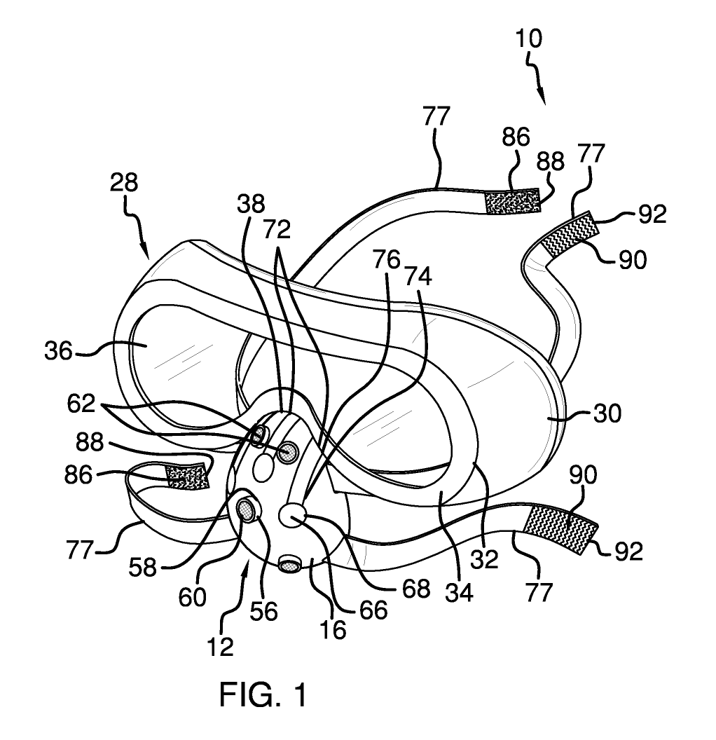

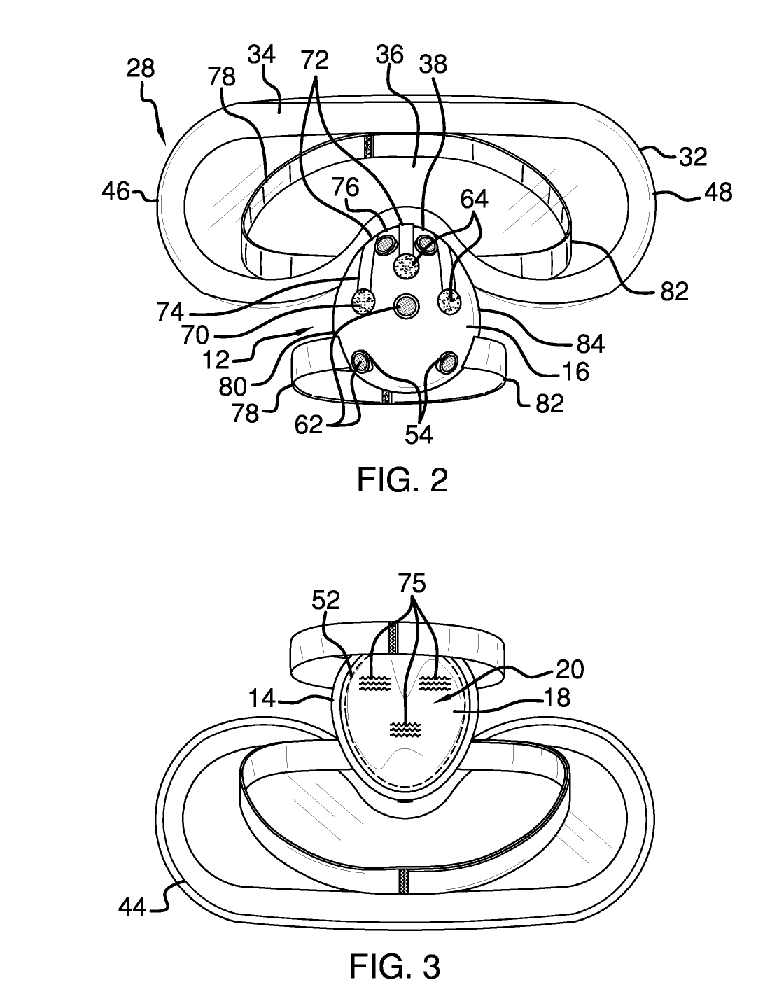

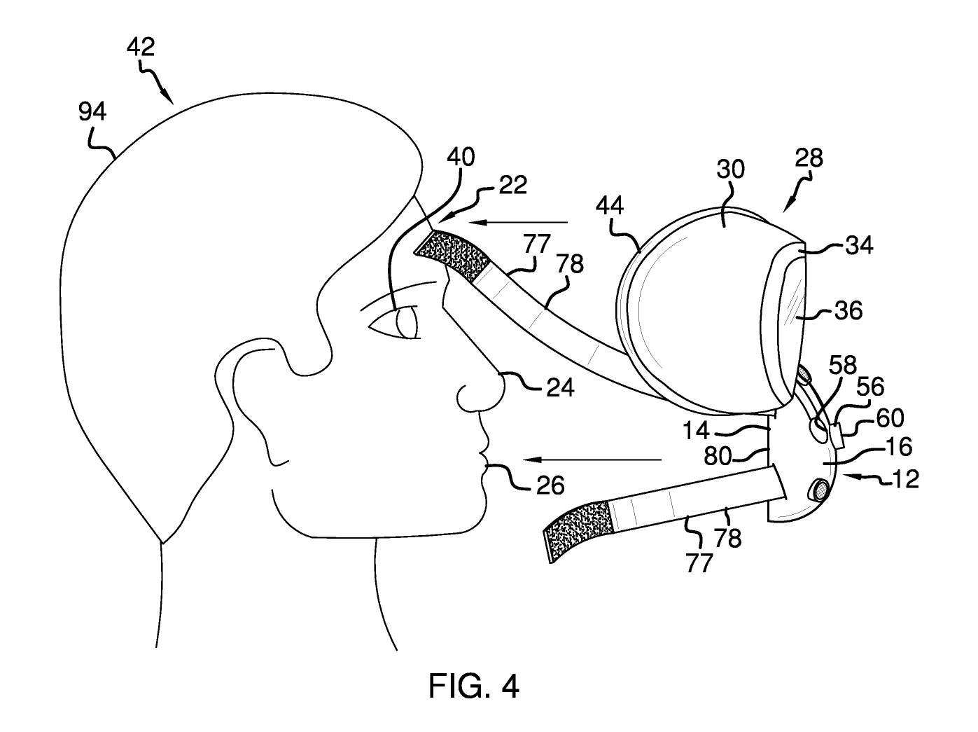

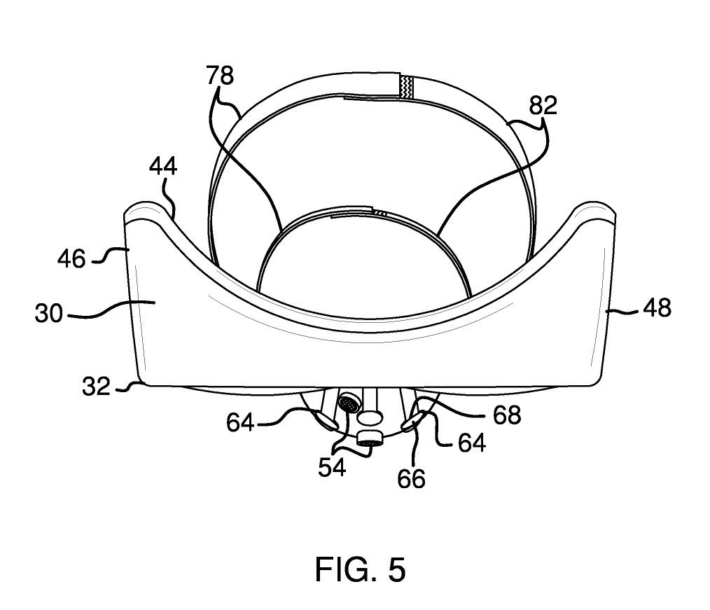

With reference now to the drawings, and in particular to FIGS. 1 through 5 thereof, a new filtration device embodying the principles and concepts of an embodiment of the disclosure and generally designated by the reference numeral 10 will be described.

As best illustrated in FIGS. 1 through 5, the air filtration assembly 10 generally comprises a mask 12 that has an outer edge 14 extending between each of an outer wall 16 and an inner wall 18 of the mask 12. The inner 18 and outer 16 walls of the mask 12 are spaced apart. A sponge space 20 is defined between the inner 18 and outer 16 walls of the mask 12. The inner 18 and outer 16 walls of the mask 12 are curvilinear. The mask 12 has a cup shape. Moreover, the mask 12 is worn on a user's face 22 so the mask 12 covers the user's nose 24 and mouth 26.

A pair of goggles 28 has an exterior wall 30 coupled to and extending rearwardly from an outer edge 32 of a front wall 34 of the pair of goggles 28. The front wall 34 of the pair of goggles 28 is open. A window 36 is coupled to the front wall 34 of the pair of goggles 28. The window 36 completely closes the front wall 34 of the pair of goggles 28. The pair of goggles 28 may be of any conventional design.

The exterior wall 30 of the pair of goggles 28 is coupled to a top side 38 of the outer wall 16 of the mask 12. The pair of goggles 28 extends laterally away from opposite sides of the mask 12. The pair of goggles 28 covers the user's eyes 40 when the user 42 wears the mask 12. A rear edge 44 of the exterior wall 30 of the pair of goggles 28 curves inwardly between each of first lateral side 46 and a second lateral side 48 of the exterior wall 30 of the pair of goggles 28. The rear edge 44 of the exterior wall 30 of the pair of goggles 28 conforms to the user's face 22. The pair of goggles 28 prevents smoke or other toxic impurity in the user's environment from contacting the user's eyes 40.

A sponge 52 is positioned within the sponge space 20. The sponge 52 may be a fluid absorbing sponge of any conventional design. A plurality of air intakes 54 each has an extraneous wall 56 extending between a coupled end 58 and a free end 60 of each of the plurality of air intakes 54. The coupled 58 and free 60 ends of each of the plurality of air intakes 54 is open. Each of the plurality of air intakes 54 is substantially hollow.

The coupled end 58 of each of the pair of air intakes 54 is coupled to the outer wall 16 of the mask 12. The plurality of air intakes 54 is in fluid communication with the sponge space 20. The plurality of air intakes 54 allows air to enter through the mask 12 and the sponge 52 when the user 42 inhales. A plurality of air filters 62 is each positioned within an associated one of the pair of air intakes 54. The plurality of air filters 62 filters the air when the user 40 inhales. Each of the plurality of air filters 62 may be a particulate filter of any conventional design.

A plurality of fluid reservoirs 64 is provided. Each of the plurality of fluid reservoirs 64 has a frontmost wall 66 coupled to and extending forwardly from a rearmost wall 68 of the plurality of fluid reservoirs 64. The frontmost wall 66 of the plurality of fluid reservoirs 64 is curvilinear. The plurality of fluid reservoirs 64 each has a hemispherical shape. The rearmost wall 68 of the plurality of fluid reservoirs 64 is coupled to the outer wall 16 of the mask 12. The plurality of fluid reservoirs 64 each contains a fluid 70. The fluid 70 may be water.

A plurality of channels 72 each has a first end 74 and a second end 76. The first 74 and second 76 ends of the plurality of channels 72 are open. Each of the plurality of channels 72 is substantially hollow. Each of the plurality of channels 72 is coupled to the outer wall 16 of the mask 12. The first end 74 of each of the plurality of channels 72 is fluidly coupled to an associated one of the plurality of fluid reservoirs 64. The second end 76 of the plurality of channels 72 is in fluid communication with the sponge space 20.

The plurality of fluid reservoirs 64 are compressed by the user 40 when the user 40 wears the mask 12. The fluid 70 within each of the plurality of fluid reservoirs 64 travels through each of the plurality of channels 72. The fluid 70 is dispersed into the sponge 52 so the sponge 52 filters particles from the air when the user 40 inhales. The inner wall 18 of the mask 12 has a plurality of air slits 75 extending therethrough. The filtered air passes through each of the plurality of air slits 75 when the user 40 inhales.

A plurality of straps 77 is coupled to the outer wall 16 of the mask 12. A first set 78 of the plurality of straps 77 extend laterally away from a first oblique side 80 of the mask 12. A second set 82 of the plurality of straps 77 extend laterally away from a second oblique side 84 of the mask 12. A pair of first couplers 86 is coupled to an associated one of each of the first set of straps 78 proximate a free end 88 of the first set of straps 78. A pair of second couplers 90 is coupled to an associated one of each of the second set of straps proximate an uncoupled end 92 of the second set of straps 82. The pair of first 86 and second 90 couplers are complimentary.

Each of the first 78 and second 82 sets of straps are extended around the user's head 94 when the user 40 wears the mask 12. The pair of first 86 and second 90 couplers retain the plurality of straps 77 around the user's head 94. Each of the pair of first 86 and second 90 couplers may comprise a hook and loop fastener of any conventional design.

In use, the assembly 10 is stored near the user 40. The user 40 wears the assembly 10 when the user 40 is exposed to smoke or other toxic atmosphere. The user 40 compresses each of the plurality of fluid reservoirs 64 so the sponge 52 is soaked in the fluid 70. The user 40 breathes normally through the mask 12 until the user 40 is able to exit the toxic atmosphere.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An air filtration assembly configured to be worn by a user when the user is in a smoke filled environment wherein said assembly provides clean air for the user to breathe, said assembly comprising:
a mask configured to be worn on the user's face;
a pair of goggles coupled to said mask such that said pair of goggles covers the user's eyes when the user wears said mask;
a sponge coupled to said mask;
a plurality of air intakes coupled to said mask, said plurality of air intakes allowing air to enter through said mask and said sponge when the user inhales; and
a plurality of fluid reservoirs coupled to said mask, said plurality of fluid reservoirs each containing a fluid, said plurality of fluid reservoirs being compressed by the user when the user wears said mask such that said fluid is dispersed into said sponge, said sponge filtering particles from the air when the user inhales.

2. The assembly according to claim 1, further comprising said mask having an outer edge extending between each of an outer wall and an inner wall of said mask, said inner and outer walls of said mask being spaced apart such that a sponge space is defined between said inner and outer walls of said mask.

3. The assembly according to claim 1, further comprising said mask being worn on the user's face such that said mask covers the user's nose and mouth.

4. The assembly according to claim 1, further comprising said pair of goggles having an exterior wall coupled to and extending rearwardly from an outer edge of a front wall of said pair of goggles.

5. The assembly according to claim 1, further comprising an exterior wall of said pair of goggles being coupled to a top side of an outer wall of said mask such that said pair of goggles extends laterally away from opposite sides of said mask.

6. The assembly according to claim 1, further comprising said plurality of air intakes each having an extraneous wall extending between a coupled end and a free end of each of said plurality of air intakes, said coupled and free ends of each of said plurality of air intakes being open, each of said plurality of air intakes being substantially hollow.

7. The assembly according to claim 1, further comprising a coupled end of each of said pair of air intakes being coupled to a outer wall of said mask such that said plurality of air intakes is in fluid communication with a sponge space.

8. The assembly according to claim 1, further comprising a plurality of air filters each being positioned within an associated one of each of said plurality of air intakes such that said plurality of air filters filters the air when said user inhales.

9. The assembly according to claim 1, further comprising said plurality of fluid reservoirs each having a frontmost wall coupled to and extending forwardly from a rearmost wall of said plurality of fluid reservoirs, said frontmost wall of said plurality of fluid reservoirs being curvilinear such that said plurality of fluid reservoirs has a hemispherical shape.

10. The assembly according to claim 1, further comprising a rearmost wall of said plurality of fluid reservoirs being coupled to an outer wall of said mask.

11. The assembly according to claim 1, further comprising a plurality of channels each having a first end and a second end, said first and second ends of said plurality of channels being open, said plurality of channels being substantially hollow.

12. The assembly according to claim 1, further comprising each of said plurality of channels being coupled to an outer wall of said mask such that a first end of each of said plurality of channels is fluidly coupled to an associated one of said plurality of fluid reservoirs, a second end of said plurality of channels being in fluid communication with a sponge space.

13. The assembly according to claim 1, further comprising said sponge being positioned within a sponge space.

14. The assembly according to claim 1, further comprising said fluid within each of said plurality of fluid reservoirs travelling through each of a plurality of channels and when the user compresses each of said plurality of fluid reservoirs.

15. The assembly according to claim 1, further comprising an inner wall of said mask having a plurality of air slits extending therethrough such that the filtered air passes through each of said plurality of air slits when the user inhales.

16. An air filtration assembly configured to be worn by a user when the user is in a smoke filled environment wherein said assembly provides clean air for the user to breathe, said assembly comprising:
a mask having an outer edge extending between each of an outer wall and an inner wall of said mask, said inner and outer walls of said mask being spaced apart such that a sponge space is defined between said inner and outer walls of said mask, said mask being worn on the user's face such that said mask covers the user's nose and mouth;
a pair of goggles having an exterior wall coupled to and extending rearwardly from an outer edge of a front wall of said pair of goggles, said exterior wall of said pair of goggles being coupled to a top side of said outer wall of said mask such that said pair of goggles extends laterally away from opposite sides of said mask such that said pair of goggles covers the user's eyes when the user wears said mask;
a sponge positioned within said sponge space;
a plurality of air intakes each having an extraneous wall extending between a coupled end and a free end of each of said plurality of air intakes, said coupled and free ends of each of said plurality of air intakes being open, each of said plurality of air intakes being substantially hollow, said coupled end of each of said pair of air intakes being coupled to said outer wall of said mask such that said plurality of air intakes is in fluid communication with said sponge space, said plurality of air intakes allowing air to enter through said mask and said sponge when the user inhales;
a plurality of air filters each being positioned within an associated one of each of said plurality of air intakes such that said plurality of air filters filters the air when said user inhales;
a plurality of fluid reservoirs each having a frontmost wall coupled to and extending forwardly from a rearmost wall of said plurality of fluid reservoirs, said frontmost wall of said plurality of fluid reservoirs being curvilinear such that said plurality of fluid reservoirs has a hemispherical shape, said rearmost wall of said plurality of fluid reservoirs being coupled to said outer wall of said mask, said plurality of fluid reservoirs each containing a fluid;
a plurality of channels each having a first end and a second end, said first and second ends of said plurality of channels being open, said plurality of channels being substantially hollow, each of said plurality of channels being coupled to said outer wall of said mask such that said first end of each of said plurality of channels is fluidly coupled to an associated one of said plurality of fluid reservoirs, said second end of said plurality of channels being in fluid communication with said sponge space;
said plurality of fluid reservoirs being compressed by the user when the user wears said mask such that said fluid within each of said plurality of fluid reservoirs travelling through each of said plurality of channels, said fluid being dispersed into said sponge such that said sponge filters particles from the air when the user inhales; and
said inner wall of said mask having a plurality of air slits extending therethrough such that the filtered air passes through each of said plurality of air slits when the user inhales.
